(19) United States
(12) Patent Application Publication
(10) Pub. No.: US 2026/0366853 A1
(43) Pub. Date: Nov. 19, 2026

(54) Pipe Tape Measure

(71) Applicant: Milwaukee Electric Tool Corporation, Brookfield, WI (US)

(72) Inventor: Thomas J. Schneider, Milwaukee, WI (US)

(21) Appl. No.: 19/575,131

(22) Filed: Mar. 23, 2026

Related U.S. Application Data
(60) Provisional application No. 63/807,004, filed on May 16, 2025.

(51) Int. Cl. G01B 3/1005; G01B 3/1003; G01B 3/1043

(52) U.S. Cl. CPC G01B 3/1005; G01B 3/1003; G01B 3/1043; G01B 2003/1023

(57) ABSTRACT

A pipe groove tape measure is provided. The tape measure includes a housing defining an internal cavity, an opening in the housing, a channel connecting the opening to the internal cavity, and a tape blade. The tape blade includes at least one recessed section formed along the tape blade between a first end and a second end of the tape blade. The tape measure further includes a wireform loop surrounding the channel. The wireform loop surrounds a portion of the tape blade positioned within the channel, and wherein the wireform loop is configured to reduce engagement between the tape blade and the housing.

### CROSS-REFERENCE TO RELATED PATENT APPLICATION

The present application claims the benefit of and priority to 63/807,004 filed on May 16, 2025, which is incorporated herein by reference in its entirety.

### BACKGROUND OF THE INVENTION

The present invention relates generally to the field of tools. The present invention relates specifically to a tape measure, measuring tape, retractable rule, etc., that includes a flat tape blade with one or more recessed portions. Such a tape blade is configured to measure a dimension of a round object such as a pipe, hose, groove, etc.

Tape measures are measurement tools used for a variety of measurement applications, including in the building and construction trades. Some tape measures include a graduated, marked blade wound on a reel and also include a retraction system for automatically retracting the blade onto the reel. In some such tape measure designs, the retraction system is driven by a coil or spiral spring that is tensioned, storing energy as the tape is extended, and that releases energy to spin the reel, winding the blade back onto the reel such that automatic or non-manual tape retraction is provided. In some other tape measure designs, retraction of the tape is controlled via a manual crank, and such tape measure blades tend to have a long length.

### SUMMARY OF THE INVENTION

One embodiment of the invention relates to a pipe tape measure including a housing defining an internal cavity, a reel rotatably mounted within the internal cavity, and a tape blade wound around the reel. An opening is formed in the housing, and a channel extends between the opening and the internal cavity. The tape blade includes a first end and a second end opposite the first end. The second end extends through the opening. The tape blade further includes a first edge extending from the first end to the second end, a second edge opposite the first edge and extending from the first end to the second end, an upper surface extending between the first edge and the second edge, and a lower surface opposite the upper surface and extending between the first edge and the second edge. At least one recessed section is formed along the tape blade between the first end and the second end. A first width is defined at the second end between the first edge and the second edge. A second width defined along the at least one recessed section between the first edge and the second edge. The second width is less than the first width. The pipe tape measure further includes a wireform loop surrounding the channel. The wireform loop surrounds a portion of the tape blade positioned within the channel, and the wireform loop is configured to reduce engagement between the tape blade and the housing.

Another embodiment of the invention relates to a tape measurement device for a pipe. The tape measurement device includes a housing defining a cavity, a reel rotatably mounted within the cavity of the housing, and an elongate blade. The elongate blade includes a first end, a second end opposite the first end along a longitudinal axis, a first side extending between the first end and the second end, and a second side opposite the first side and extending between the first end and the second end. The first end is coupled to the reel and positioned within the housing. The elongate blade further includes a first recessed portion positioned along the elongate blade between the first end and the second end. The first recessed portion is formed along the first side of the elongate blade. The first recessed portion includes a first angled edge extending towards the longitudinal axis and a second angled edge extending away from the longitudinal axis. An opening is defined by the housing. A wireform loop is positioned within the housing between the opening and the cavity. The wireform loop is configured to surround a portion of the elongate blade as it extends through the opening to an exterior of the housing.

Another embodiment of the invention related to a pipe groove tape measure. The pipe groove tape measure includes a housing, a reel, a tape blade, and a guide member. The housing includes an outer wall, an internal cavity defined within the housing, and a first opening. The first opening extends from the outer wall to the internal cavity. The reel is rotatably mounted within the internal cavity. The tape blade includes a first end coupled to the reel, a second end opposite the first end, a first surface extending between the first end and the second end, and a second surface opposite the first surface where the second surface extends between the first end and the second end. The first surface is flat. The second surface is flat. The tape blade is movable between a first position and a second position. When in the first position, a length of the tape blade defined between the first end and the second end is positioned within the housing and wound around the reel. When in the second position, the length extends out of the first opening to an exterior of the housing. The guide member is positioned between the first opening and the internal cavity. The guide member defines a second opening configured to surround a portion of the tape blade as the tape blade moves between the internal cavity and the exterior of the housing.

Additional features and advantages will be set forth in the detailed description which follows and will be readily apparent to those skilled in the art from the description or recognized by practicing the embodiments as described in the written description and/or shown in the accompanying drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a pipe tape measure, according to an exemplary embodiment;

FIG. 2 is a perspective view of the pipe tape measure of FIG. 1 showing internal components, according to an exemplary embodiment;

FIG. 3 is a perspective view of the pipe tape measure of FIG. 1 with a portion of the tape blade extended from the housing, according to an exemplary embodiment;

FIG. 4 is a detailed cross-sectional view of a portion of the tape measure housing, according to an exemplary embodiment;

FIG. 5 is a detailed perspective view of the wireform loop of FIG. 4, according to an exemplary embodiment;

FIG. 6 is a detailed perspective view of a distal end of the tape blade and a tape blade hook assembly, according to an exemplary embodiment;

FIG. 7 is a front perspective view of the distal end of the tape blade, according to an exemplary embodiment;

FIG. 8 is a plan view of a portion of a tape blade of a pipe tape measure, according to an exemplary embodiment;

FIG. 9 is a plan view of another portion of the tape blade of a pipe tape measure, according to an exemplary embodiment;

FIG. 10 is a plan view of a portion of a tape blade of a pipe tape measure, according to an exemplary embodiment;

FIG. 11 is a detailed view of the tape blade of FIG. 10, according to an exemplary embodiment;

FIG. 12 is a detailed view of an edge of the tape blade of FIG. 11, according to an exemplary embodiment;

FIG. 13 is a detailed view of the edge of FIG. 12, according to an exemplary embodiment;

FIG. 14 is a plan view of a portion of a painted tape blade of a pipe tape measure, according to an exemplary embodiment;

FIG. 15 is a detailed view of another portion of the painted tape blade of FIG. 14, according to an exemplary embodiment;

FIG. 16 is a plan view of a tape blade of a pipe tape measure relative to a measuring device, according to an exemplary embodiment.

### DETAILED DESCRIPTION

Referring generally to the figures, various embodiments of a pipe tape measure are shown. As will be generally understood, a pipe tape measure and more specifically a pipe groove tape measure are used to measure a diameter of round objects such as a pipe and/or to confirm a groove formed on the pipe has a desired depth. The pipe groove tape measures discussed herein include a flat blade unlike conventional tape measure blades that may have a U-shaped profile. Further, unlike conventional tape blades, the tape blades discussed herein include one or more angled and/or recessed sections that allow for wrapping the tape blade around the round object. In other words, the tape blade has a non-linear shape. In specific embodiments, the tape blades discussed herein include non-linear markings.

In various embodiments, the pipe tape measure includes a wireform loop positioned in the housing. In specific embodiments, the wireform loop is positioned in the housing and surrounds the tape port opening. In contrast to conventional tape measures where the tape blade and tape blade edges may become damaged and worn after extension and retraction, the tape measures discussed herein include the wireform loop to protect the blade from wear. Applicant believes the wireform loop reduces wear and/or damage to the tape during extension and/or retraction of the tape blade by avoiding interference and/or scraping against the housing around the tape port.

In various embodiments, the pipe tape measure and specifically the tape blade includes a polymer material at a distal end of the tape blade. The polymer material is positioned between the tape blade and a connecting plate for an end loop that is coupled to the distal end of the tape blade. In specific embodiments, the polymer material is formed into a polymer tube. Applicant believes the polymer material provides a cushion that reduces tape blade tearing at the contact points of the connection plate and the tape blade. In a specific embodiment, the polymer extends at least 5 mm past an interior end of the connecting plate. Applicant believes the extension of the polymer layer reduces the likelihood of tape blade tearing.

In various embodiments, the pipe tape measure has a tape blade formed from a stainless steel material. In contrast, conventional blades are typically formed from carbon steel. Applicant believes the stainless steel tape blade has improved durability. In various embodiments, the tape blade is formed using laser cutting instead of stamping which is frequently used for tape blades. Applicant believes using laser cutting reduces the difficulty of forming the non-linear tape blade. As will be generally understood, stainless steel is a very ductile material meaning a stamping die would need to ground relatively frequently (e.g., every couple hundred parts) in order to keep it sharp, which is costly and time consuming, making it unsuitable for mass production. Furthermore, even using conventional carbon steel material, the long tapered shape of the blades still require resharpening of the die sections (e.g., every thousand parts).

Additionally, the mating portions of the die are frequently wide at various sections causing burrs along both sides of portions of the length of the blade. As will be generally understood, burrs can cause interference with the movement of the blade (e.g., jam tape measure, extra wear on components), cut and/or scrape user, etc. In contrast, the laser cut blade will have an edge burr along one or more sides of the blade.

Furthermore, as will be generally understood, tape blades are frequently painted such as to improve the visual contrast of markings. However, for tape blades formed using conventional stamping, there is paint removal and/or flaking on the tape blade. Paint flaking on the tape blade may cause a user to have difficulty lining up the edge of the tape blade to correctly measure and/or read the tape blade. In contrast, the laser cut tape blades discussed herein are able to be cut without paint flaking due to the laser cutting. Applicant believes the lack of paint flaking improves ease of use and accuracy of measurement.

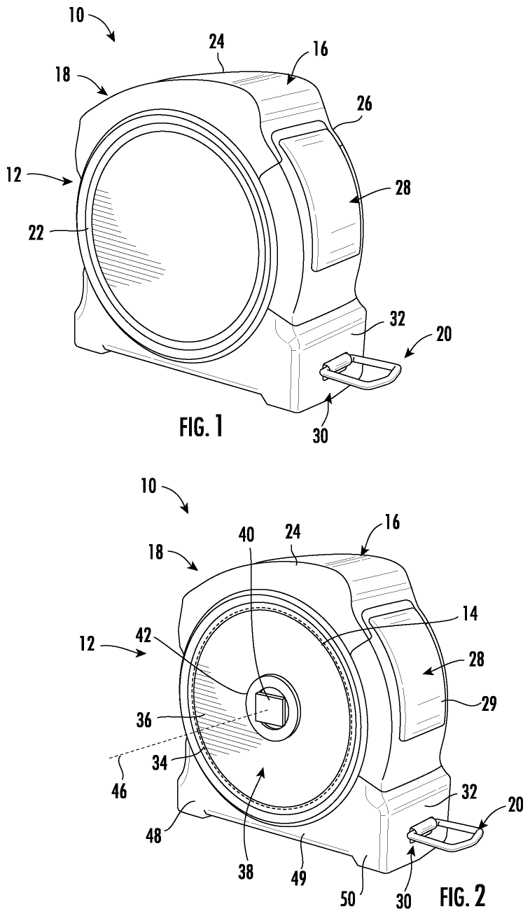

Referring to FIGS. 1-9, a length measurement device, such as a tape measurement device, shown as a pipe groove tape measure 10 is shown according to an exemplary embodiment. Pipe groove tape measure 10 includes a coilable elongate blade, shown as tape blade 14, and a housing 12. In general, tape blade 14 is an elongate strip of material including markings. In various embodiments, tape blade 14 has a first end 43 and a second or distal end 44 opposite first end 43. Tape blade 14 includes opposing edges that extend from first end 43 to distal end 44. In a specific embodiment, tape blade 14 has a length measured between first end 43 and distal end 44 between 0.1 and 7 ft. In specific embodiments, tape blade 14 has a length of about 7 ft. Tape blade 14 further includes a first or upper surface 45 extending between the opposing edges and a second or lower surface 47 opposite upper surface 45. Upper surface 45 and lower surface 47 extend between a first side 71 and a second side 73 opposite first side 71. The width is variable between opposing edges such that tape blade has a non-linear shape. In specific embodiments, tape blade 14 is an elongate strip of metal material (e.g., steel material) that includes outermost or distal end 44 coupled to a hook assembly, shown as hook assembly 20. As will be discussed in greater detail below, in various embodiments, tape blade 14 may include a cover (e.g., polymer cover) to help protect tape blade 14 from cracking during whip or pinch.

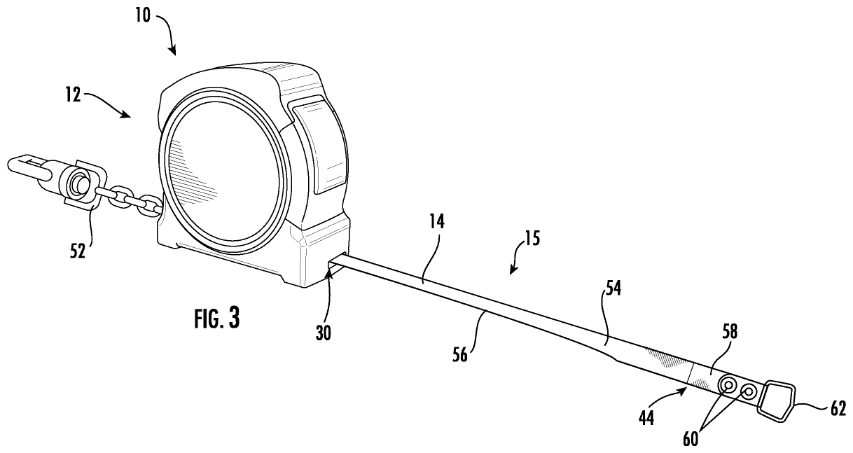

Further, tape blade 14 may include any combination of tape blade features of the various embodiments discussed herein. Specifically, in various embodiments, tape blade 14 includes a flat profile shape (i.e., upper surface 45 is flat and/or lower surface 47 is flat). That is, upper surface 45 and lower surface 47 of the tape blade 14 are substantially parallel to each other. Further, tape blade 14 includes one or more angled and/or recessed sections that allow for improved ease of wrapping the tape blade 14 around a round object such as a pipe. As shown in FIG. 3, a length of the tape blade 14 is extended from housing 12. A hook assembly 20 is fixedly coupled to distal end 44 of tape blade 14.

As shown in FIG. 2, the non-extended portion of tape blade 14 is wound onto a reel 34, which is surrounded by housing 12. Reel 34 is rotatably mounted within housing 12, and more specifically, is mounted in internal cavity 64. Reel 34 is rotatably disposed about an axle 40 that defines an axis of rotation 46 of tape measure 10. Pipe groove tape measure 10 further includes a retraction mechanism 42 for driving rewinding of tape blade 14 onto reel 34. Retraction mechanism 42 is coupled to reel 34 and configured to drive reel 34 about axis of rotation 46 which in turn provides powered retraction of tape blade 14. In specific embodiments, retraction mechanism 42 is positioned at least partially within a bore 38 of reel 34 defined by an interior surface 36 of reel 34. Interior surface 36 faces and surrounds the axle 40. Retraction mechanism 42 may include one or more springs such as elongated spiral springs, flat springs, etc. that provide the retraction energy to retraction mechanism 42. A locking mechanism, shown as tape lock 28, is provided to selectively engage tape blade 14, which acts to restrain retraction mechanism 42 such that extended segment 15 of tape blade 14 remains at a desired length.

Referring to FIG. 1, in various embodiments, housing 12 includes an outer wall that defines internal cavity 64. In particular, housing 12 includes a first housing portion 16 and a second housing portion 18 that together enclose an internal cavity. Housing 12 includes a first side wall 22, a second side wall 26, and a peripheral wall 24 connecting first side wall 22 and second side wall 26, which together may define the outer wall of housing 12. First side wall 22, second side wall 26, and peripheral wall 24 together define the internal cavity 64, shown in FIG. 4, in which reel 34 and retraction mechanism 42 are housed. The side walls 22, 26 may be rectangular, polygonal, or any other desired shape. Portions 16, 18 of the housing 12 may be co-molded or separately formed of a resilient material, such as a natural or synthetic rubber. In the illustrated construction, housing 12 is formed with a front support leg 50 which extends from a lower portion of the peripheral wall 24 and a rear support leg 48 that opposes front support leg 50. A bottom surface 49 of housing 12 extends between and connects front support leg 50 to rear support leg 48.

A slot 29 is defined along a forward portion 32 of peripheral wall 24. Slot 29 provides an opening in the tape measure housing 12 which allows tape lock 28 to extend into housing 12. In addition, slot 29 provides a length sufficient to allow tape lock 28 to be moved relative to housing 12 between locked and unlocked positions. Below the slot 29, an opening shown as tape port 30 is provided in peripheral wall 24. Tape port 30 is formed in peripheral wall 24 of housing 12. Tape port 30 allows for the retraction and extension of tape blade 14 to and from the internal cavity 64 defined within housing 12.

Referring to FIG. 3, details of pipe groove tape measure 10 are shown according to an exemplary embodiment. As shown in FIG. 1, when tape blade 14 is in a retracted position, tape blade 14 is positioned within housing 12. When tape blade 14 is in an extended position (see e.g., FIG. 3), the tape blade 14 extends from housing 12 out of tape port 30. In various embodiments, a clip, shown as a keychain clip 52 is coupled to housing 12. Keychain clip 52 allows a user to quickly secure pipe groove tape measure 10 to belt, keys, tool bag, etc.

Tape blade 14 and specifically distal end 44 of tape blade 14 is coupled to and/or supports a hook assembly 20. Hook assembly 20 includes a hook or end loop 62 coupled to tape blade 14 by a connection plate 58. Loop 62 is secured to connection plate 58 and/or tape blade 14 by one or more fasteners, shown as rivets 60. Rivets 60 extend through rivet holes 59 defined in connection plate 58.

As previously discussed, tape blade 14 is a flat blade that include one or more angled and/or recessed sections that allow for easier wrapping of the tape blade 14 around round objects such as a pipe. In other words, in various embodiments, the tape blade 14 has a non-linear shape. For example, as shown in FIG. 3, a first portion 54 of tape blade 14 connected to distal end 44 has a first dimension. In specific embodiments, first portion 54 of tape blade 14 has a first width (e.g., dimension perpendicular to a length of tape blade 14). In a specific embodiment, the first width is defined between a first edge 86 and an opposing second edge 88 (see e.g., FIG. 8). First portion 54 of tape blade 14 is positioned between distal end 44 and a second portion 56 of tape blade 14. Second portion 56 of tape blade 14 has a second dimension. In specific embodiments, second portion 56 of tape blade 14 has a second width (e.g., dimension perpendicular to a length of tape blade 14). In various embodiments, the second dimension is different than the first dimension. In specific embodiments the second dimension is less than the first dimension.

Referring to FIG. 4, a detailed cross-sectional view of a portion of housing 12 is shown according to an exemplary embodiment. Housing 12 includes cavity 64 that connects to tape port 30. A guide member, shown as wireform loop 66, is positioned within housing 12 and more specifically positioned to surround a channel 67 defined by tape port 30. Channel 67 extends between tape port 30 and cavity 64. Wireform loop 66 is positioned in a recessed section 69 defining a recessed surface of housing 12 positioned adjacent to (e.g., rearward from tape port 30 in orientation shown in FIG. 4) forward portion 32 of peripheral wall 24. Recessed section 69 surrounds the tape blade 14 as it is extended and/or retracted from housing 12. In other words, tape blade 14 moves through channel 67 and exits the housing 12 through the tape port opening 30. Wireform loop 66 surrounds a portion of tape blade 14 when it is positioned within channel 67. As previously discussed, Applicant believes the wireform loop 66 reduces wear and/or damage to the tape blade 14 during extension and/or retraction of the tape blade 14 by avoiding damage that may be caused by rubbing or whipping against the housing 12 around the tape port 30.

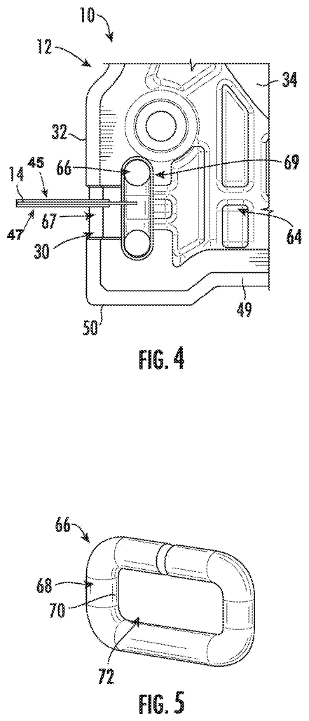

Referring to FIG. 5, details of wireform loop 66 are shown according to an exemplary embodiment. Wireform loop 66 is formed from a metal material. In a specific embodiment, the material is stainless steel. In a specific embodiment, wireform loop is formed from SUS304 stainless steel. In various embodiments, wireform loop 66 includes a rounded shape. Applicant believes this shape reduces wear on tape blade 14 particularly along edges of tape blade 14 during retraction compared to conventional tape measures where the tape blade may be damaged by the housing and/or sharp corners.

As shown in FIG. 5, wireform loop 66 includes a body 68. In specific embodiments, body 68 has a generally cylindrical shape (e.g., a circular cross-section). Body 68 includes an interior surface 70 that defines an opening, shown as elongate opening 72. In specific embodiments, elongate opening 72 has a generally rectangular shape. Wireform loop 66 provides 360 degree protection around tape blade 14 when wireform loop 66 is positioned in housing 12. As will be generally understood, any small gap in the wireform loop 66 is narrow such that the blade will not be caught in the gap, therefore providing 360 degree protection.

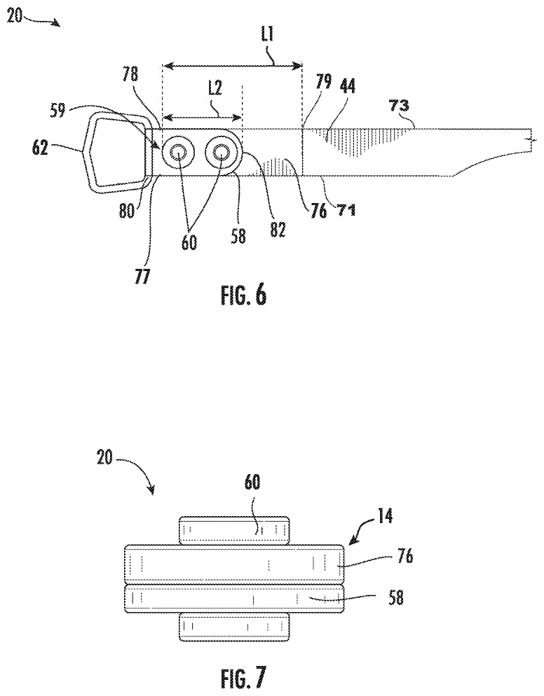

Referring to FIGS. 6-7, details of distal end 44 of tape blade 14 and the connection to hook assembly 20 are shown according to an exemplary embodiment. In various embodiments, a polymer cover 76 is positioned between tape blade 14 and connection plate 58 for end loop 62. Applicant believes the polymer material provides a cushion that prevents the connection plate 58 from digging into tape blade 14 and snapping or breaking the tape blade 14 (e.g., during retraction, whip, etc.).

In specific embodiments, polymer cover 76 is a heat shrink tube. In such embodiments, the heat shrink tube is formed from at least one of polyethylene terephthalate (PET), polyethylene (PE), thermoplastic polyurethane (TPU), and thermoplastic rubber (TPR). In specific embodiments, polymer cover 76 is formed from PET. As will generally be understood, polymer cover 76 is shaped to cover an upper surface, an opposing lower surface, and opposing lateral edges of tape blade 14.

Polymer cover 76 extends from an outermost or distal end 78 to a second end 79 that opposes outermost end 78. In a specific embodiment, polymer cover 76 extends beyond a front rivet hole 59. The front rivet hole 59 is positioned between rear rivet hole 59 and end loop 62. In a specific embodiment, polymer cover 76 and specifically distal end 78 extends beyond front rivet hole 59 by about 1 mm.

A length, L1, of polymer cover 76 is defined between outermost end 78 and second end 79. Connection plate 58 extends from an outermost end 80 that is engaged with loop 62 to a second, inner end 82. A length, L2, of connection plate 58 is defined between outermost end 80 and second end 82. In various embodiments, L1 is different than L2. In various embodiments, L1 is greater than L2.

In various embodiments, polymer cover 76 and specifically second end 79 extends beyond or past inner end 82 of connection plate 58. In a specific embodiment, polymer cover 76 and specifically second end 79 extends beyond inner end 82 of connection plate 58 by at least 5 mm. Applicant believes the extension of the polymer layer beyond a bend point of the connection plate reduces the likelihood of tape blade tearing.

In various embodiments, blade 14 has a first thickness defined between the upper surface 45 and the lower surface 47 of blade 14. In various embodiments, a second thickness is defined as a total thickness of a paint thickness, a coating thickness, and polymer cover 76. In other various embodiments, the second thickness is defined between a lower surface of tape blade 14 and a top surface of polymer cover 76. In specific embodiments, the ratio of the second thickness to the first thickness is 2:1. Applicant believes the ratio of the second thickness to the first thickness creates a large enough radius as tape blade 14 bends such that the tape blade 14 does not reach a critical bending point (e.g., does not break, etc.).

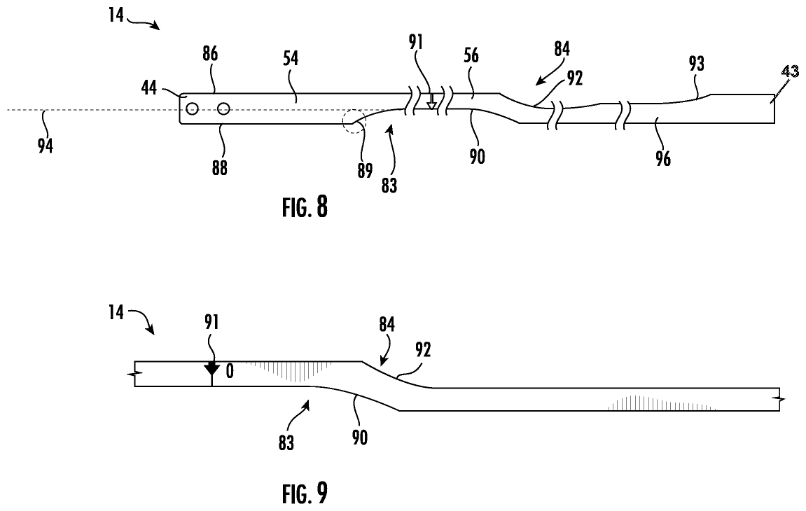

Referring to FIGS. 8-9, details of tape blade 14 are shown, according to an exemplary embodiment. As previously discussed, tape blade 14 include one or more angled and/or recessed sections. In various embodiments, a first recessed portion 83 is formed along first side 71 of tape blade 14. First recessed portion 83 extends from and/or is connected to first portion 54 of tape blade 14. In specific embodiments, first recessed portion 83 includes a first angled edge 89 that extends inward, toward a longitudinal axis 94 of tape blade 14. First recessed portion 83 further includes a second angled edge 90 that extends outward, away from longitudinal axis 94.

In specific embodiments, tape blade 14 includes a second recessed portion 84 formed along second side 73. Second recessed portion 84 is recessed in an opposing direction from first recessed portion 83. First recessed portion 83 is positioned between second recessed portion 84 and distal end 44. In specific embodiments, second recessed portion 84 includes a third angled edge 92 that extends inward, toward longitudinal axis 94 and a fourth angled edge 93 that extends outward, away from longitudinal axis 94. In specific embodiments, angled edges 89, 90, 92, 93 are curved edges.

In various embodiments, the tape blade 14 is formed using laser cutting. As will be discussed in greater detail below, laser cutting may impact edge conditions of tape blade 14. In a specific embodiment, tape blade 14 is formed from stainless steel. For example, in a specific embodiment, tape blade 14 is formed from SUS301. In various embodiments, tape blade 14 is formed from at least one of a 300 series stainless steel material or a 400 series stainless steel material. In various embodiments, tape blade 14 is formed from a material having a relatively high ductility. In various embodiments, tape blade 14 has good corrosion resistance.

As previously discussed, in various embodiments, tape blade 14 includes non-linear markings. In various embodiments, tape blade 14 includes a zero mark 91. In specific embodiments, the zero mark 91 has an arrow indicator. Tape blade 14 further includes one or more markings (see e.g., 96) that indicate different diameters. As will be generally understood, in use, tape blade 14 is wrapped around an object (pipe, groove, etc.) and a diameter can be determined by the marking alignment with the zero mark 91.

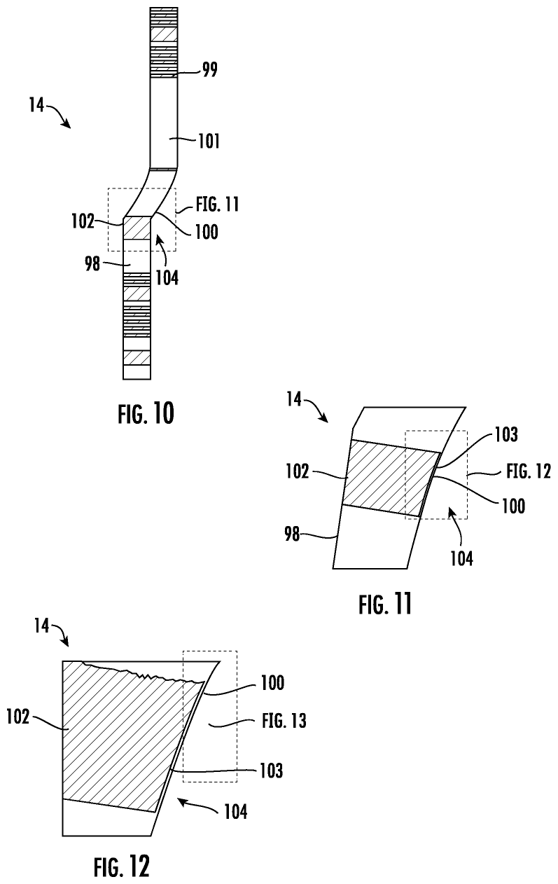

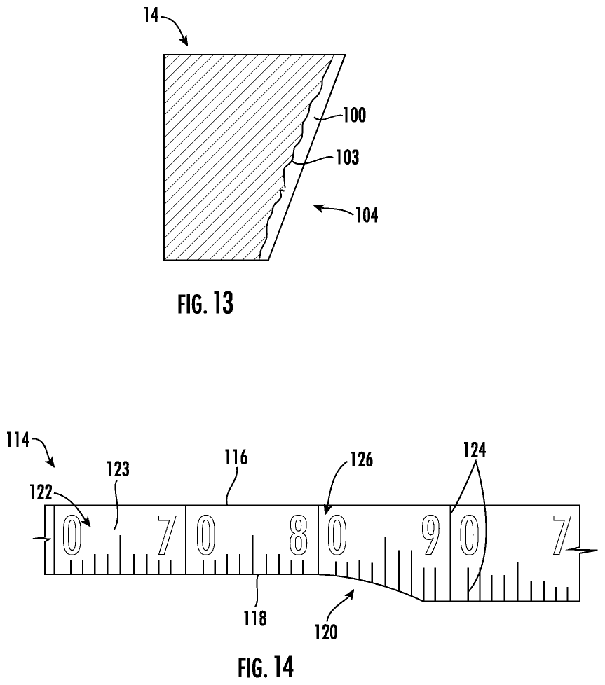

Referring to FIGS. 10-13, details of the edge condition of tape blade 14 are shown according to an exemplary embodiment. As previously discussed, Applicant believes the laser cut blade 14 will have an edge burr (or raised edge) along a single side of the blade 14. Blade 14 includes an exterior surface 101 with an upper blade surface 99 and a lower blade surface (i.e., surface opposing upper blade surface 99) that each extend between opposing lateral edges 98, 100. Lateral edge 100 includes one or more recessed portions 104. Blade 14 includes a plurality of markings 102.

As shown in detailed views 11-13, first side 71 of tape blade 14, and more specifically lateral edge 100, includes a burr or raised edge, shown as edge burr 103. Edge burr 103 extends inward from lateral edge 100 and toward opposing lateral edge 98. In various embodiments, edge burr 103 has a dimension less than a maximum dimension.

Referring to FIGS. 14-15, details of the edge condition of a tape blade 114 are shown according to another exemplary embodiment. Tape blade 114 can be utilized with pipe groove tape measure 10. Tape blade 114 is substantially the same as tape blade 14 except for the differences discussed herein.

As will be generally understood, many tape blades are painted for various reasons including improving or enhancing visibility. For example, paint may enhance visibility of the blade particularly in dim environments and the contrast between a bright color paint and markings is easier for a user to read. However, stamping of painted tape blade may damage edges of the blade and such paint flaking reduces the benefits of painting the tape blade.

Tape blade 114 includes an exterior surface 122. In various embodiments, exterior surface 122 includes an upper blade surface and an opposing lower blade surface. The upper blade surface 99 and lower blade surface each extend between opposing lateral edges 116 and 118. Lateral edge 118 includes one or more recessed portions 120.

Exterior surface 122 includes paint 123 over a metal core. In specific embodiments, the core of tape blade 114 is formed from SUS301 and painted a color, such as yellow. In other embodiments, paint 123 has a different bright color (e.g., white, green, etc.). A plurality of markings 124 are positioned on paint 123. In specific embodiments, the markings 124 are made in a darker color than paint 123 such that there is a contrast between the paint 123 and markings 124. In various embodiments, tape blade 114 further includes indicia, shown as numerical labels 126.

As can be seen in FIGS. 14-15, paint 123 on exterior surface 122 is not chipped or flaked along either lateral edge 116, 118. Therefore, the markings 124 and labels 126 are clear and visible to a user. In various embodiments, paint 123 has a thickness greater than a minimum thickness.

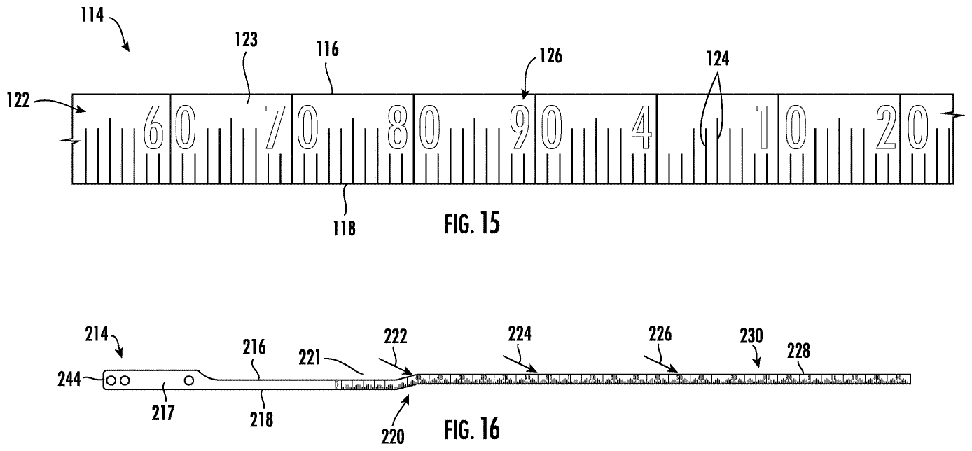

Referring to FIG. 16, details of an edge condition of laser cut tape blade 214 are shown according to an exemplary embodiment. As will be generally understood, heat from the laser may impact the edge condition of tape blade 214. For example, the laser may burn and/or warp the edge of the tape blade.

Tape blade 214 can be utilized with pipe groove tape measure 10. Tape blade 214 is substantially the same as tape blades 14, 114 except for the differences discussed herein. In various embodiments, tape blade 214 includes an upper blade surface 217 and an opposing lower blade surface. The upper blade surface 217 and lower blade surface each extend between opposing lateral edges 216 and 218. Lateral edge 218 includes one or more recessed portions 220. Similarly, lateral edge 216 includes one or more recessed portions 221.

As previously discussed, the use of a laser to cut tape blade 214 can impact edge conditions including the straightness of lateral edges 216, 218. As shown in FIG. 16, distal end 244 of tape blade 214 is spaced from an adjacent edge 228 of a measurement device 230. However, the distance between tape blade 214 and measurement device 230 is not constant over the length of tape blade 214. In other words, tape blade 214 has a bend.

For example, at a first point 222 along lateral edge 216 at a position adjacent to recessed portion 221, tape blade 214 is spaced a first distance from adjacent edge 228. At a second point 224 along lateral edge 216, tape blade 214 is spaced a second distance from adjacent edge 228. First point 222 is positioned between distal end 244 and second point 224. In a specific embodiment, the first distance is greater than the second distance. At a third point 226 along lateral edge 216, tape blade 214 is spaced a third distance from adjacent edge 228. Second point 224 is positioned between first point 222 and third point 226. In a specific embodiment, the second distance is greater than the third distance. In such an embodiment, the first distance is greater than the second distance and the third distance. In specific embodiments, a bend of tape blade 214 is about 5 mm over a 127 mm length of tape blade 214.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions, and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths, and radii, as shown in the Figures are to scale. Actual measurements of the Figures will disclose relative dimensions, angles, and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A pipe tape measure, comprising:
a housing defining an internal cavity;
a reel rotatably mounted within the internal cavity;
an opening formed in the housing;
a channel extending between the opening and the internal cavity;
a tape blade wound around the reel, the tape blade comprising:
a first end;
a second end opposite the first end, the second end extending through the opening;
a first edge extending from the first end to the second end;
a second edge opposite the first edge and extending from the first end to the second end;
an upper surface extending between the first edge and the second edge;
a lower surface opposite the upper surface and extending between the first edge and the second edge;
at least one recessed section formed along the tape blade between the first end and the second end;
a first width defined at the second end between the first edge and the second edge; and
a second width defined along the at least one recessed section between the first edge and the second edge, wherein the second width is less than the first width; and
a wireform loop surrounding the channel, wherein the wireform loop surrounds a portion of the tape blade positioned within the channel, and wherein the wireform loop is configured to reduce engagement between the tape blade and the housing.

2. The pipe tape measure of claim 1, wherein the tape blade is made from stainless steel.

3. The pipe tape measure of claim 1, wherein the wireform loop comprises a body with a circular cross-section.

4. The pipe tape measure of claim 3, wherein the body of the wireform loop defines an elongate opening, wherein the elongate opening has a rectangular shape.

5. The pipe tape measure of claim 1, further comprising a retraction mechanism coupled to the reel, wherein the retraction mechanism drives rewinding of the tape blade onto the reel.

6. The pipe tape measure of claim 1, wherein the upper surface is flat.

7. The pipe tape measure of claim 1, wherein the upper surface and the lower surface are parallel to each other such that they define a flat profile of the tape blade.

8. A tape measurement device for a pipe, the tape measurement device comprising:
a housing defining a cavity;
a reel rotatably mounted within the cavity of the housing;
an elongate blade comprising:
a first end coupled to the reel and positioned within the housing;
a second end opposite the first end along a longitudinal axis;
a first side extending between the first end and the second end;
a second side opposite the first side and extending between the first end and the second end; and
a first recessed portion positioned along the elongate blade between the first end and the second end, the first recessed portion formed along the first side of the elongate blade, the first recessed portion comprising a first angled edge extending towards the longitudinal axis and a second angled edge extending away from the longitudinal axis;
an opening defined by the housing; and
a wireform loop positioned within the housing between the opening and the cavity, wherein the wireform loop is configured to surround a portion of the elongate blade as it extends through the opening to an exterior of the housing.

9. The tape measurement device of claim 8, wherein the elongate blade further comprises a second recessed portion positioned along the elongate blade between the first end and the second end, the second recessed portion formed along the second side of the elongate blade, the second recessed portion comprising a third angled edge extending towards the longitudinal axis and a fourth angled edge extending away from the longitudinal axis.

10. The tape measurement device of claim 9, wherein the first recessed portion is positioned between the second recessed portion and the second end.

11. The tape measurement device of claim 9, wherein the first angled edge, the second angled edge, the third angled edge, and the fourth angled edge are curved.

12. The tape measurement device of claim 8, wherein the housing further comprises an outer wall, wherein the opening extends through the outer wall, wherein a recessed surface is defined within the housing between the outer wall and the cavity, and wherein the wireform loop is positioned within the recessed surface.

13. The tape measurement device of claim 8, further comprising a hook assembly, the hook assembly comprising a loop and a connection plate, wherein the connection plate is coupled to the second end of the elongate blade.

14. The tape measurement device of claim 13, further comprising a cover positioned on the second end of the elongate blade between the elongate blade and the connection plate.

15. The tape measurement device of claim 14, wherein the elongate blade has a first thickness defined between an upper surface and an opposing lower surface of the elongate blade, wherein a second thickness is defined between a top surface of the cover and the lower surface of the elongate blade, and wherein the ratio of the second thickness to the first thickness is 2:1.

16. The tape measurement device of claim 8, wherein the elongate blade further comprises a burr formed along the first side of the elongate blade.

17. A pipe groove tape measure, comprising:
a housing comprising an outer wall, an internal cavity defined within the housing, and a first opening extending from the outer wall to the internal cavity;
a reel rotatably mounted within the internal cavity;
a tape blade comprising:
a first end coupled to the reel;
a second end opposite the first end,
a first surface extending between the first end and the second end, wherein the first surface is flat; and
a second surface opposite the first surface, the second surface extending between the first end and the second end, wherein the second surface is flat; and
wherein the tape blade is movable between a first position where a length of the tape blade defined between the first end and the second end is positioned within the housing and wound around the reel and a second position where the length extends out of the first opening to an exterior of the housing; and
a guide member positioned between the first opening and the internal cavity, the guide member defining a second opening configured to surround a portion of the tape blade as the tape blade moves between the internal cavity and the exterior of the housing.

18. The pipe groove tape measure of claim 17, wherein the guide member is made from stainless steel.

19. The pipe groove tape measure of claim 17, wherein the tape blade further comprises a first recessed portion positioned along the tape blade between the first end and the second end, the first recessed portion formed along a first side of the tape blade, the first recessed portion comprising a first angled edge extending towards a second side of the tape blade opposite the first side across the first surface.

20. The pipe groove tape measure of claim 17, further comprising a retraction mechanism coupled to the reel and a locking mechanism configured to move between a locked position and an unlocked position, wherein, when the locking mechanism is in the locked position, the locking mechanism engages the tape blade to restrain the retraction mechanism from rewinding the tape blade onto the reel.
